(19) United States
(12) Patent Application Publication
(10) Pub. No.: US 2004/0093333 A1
(43) Pub. Date: May 13, 2004

(54) Structured data retrieval apparatus, method, and program

(76) Inventors: Masaru Suzuki, Kawasaki-shi (JP); Shozo Isobe, Kawasaki-shi (JP); Kosei Fume, Yokohama-shi (JP); Takuya Kanawa, Yokohama-shi (JP); Kenji Ono, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/701,450

(22) Filed: Nov. 6, 2003

(30) Foreign Application Priority Data
Nov. 11, 2002 (JP) 2002-327127

(51) Int. Cl. G06F 7/00

(52) U.S. Cl. 707/3

(57) ABSTRACT

A data retrieval method includes storing information data items, each of information data items including elements, each of elements including element name and character string, storing data items, each of data items including element name of element and label corresponding to one of categories to which character string which is included in element belongs, inputting search request including keyword and first label which is one of labels, searching one of data items which includes label being equal to first label, to obtain third element name which is element name included in one of data items, searching one of information data items which includes first element which includes third element name and second element which includes character string including keyword, outputting first character string which is included in first element.

### CROSS-REFERENCE TO RELATED APPLICATIONS

This application is based upon and claims the benefit of priority from the prior Japanese Patent Application No. 2002-327127, filed Nov. 11, 2002, the entire contents of which are incorporated herein by reference.

### BACKGROUND OF THE INVENTION

1. Field of the Invention

The present invention relates to a structured data retrieval apparatus which retrieves structured data having a hierarchical data structure (logical structure) including of a plurality of elements.

2. Description of the Related Art

In a conventional relational database management system (RDBMS), the structure of a database is determined in advance, and the user can conduct a search using this structure. For example, if an attribute “PRICE” used to store a commodity price is prepared in an arbitrary commodity database, a commodity price is recorded in the “PRICE” attribute in the commodity database. The user makes a search using the “PRICE” attribute to retrieve a commodity price. As a database language (query language) used to make a search suited to a relational database, SQL (structured query language) is known.

In another technique, the user inputs a search request in a natural language, and the system interprets the search request to convert it into SQL (e.g., see Jpn. Pat. Appln. KOKAI Publication No. 5-54078). In this case, since the database structure is known, knowledge used to adjust the interpretation result of the natural language to the database structure can be prepared in advance.

In a database management system that uses recently prevalent extensible markup language (XML), a query language such as XQUERY or the like is prepared.

In XML data as one of structured data having a hierarchical logical structure consisting of a plurality of elements, the data structure of element names or the like of elements need not always be determined in advance, and a person who prepares XML data can uniquely define (or expand) the data structure of element names or the like. In XML data, the attribute can be defined as an element name of an element, i.e., a tag. For example, in a commodity database, a tag used to store a commodity price can be either a <PRICE> tag or <kakaku (“kakaku” means “price” in Japanese)> tag or can be <TAG1> In this way, the tag name can be freely set. Hence, a tag name that represents the attribute of data like <PRICE> can be used, or a tag name that does not represent the attribute of data like <TAG1> can be used. In the latter case, the user cannot determine a tag that describes a commodity price. Also, it is difficult to know the data structure by only casting a glance at data.

In this manner, upon searching structured data in the conventional system, the user must know the data structure of element names or the like of elements of structured data to be retrieved. Limiting structured data search within the range of the data structure that the user can know considerably impairs the merit of using of XML data.

In the conventional search method, upon searching a plurality of structured data with different data structures for desired structured data, the user must know all data structures in advance. Hence, it is difficult to retrieve structured data which contains an element having desired data as an element value.

The present invention has been made in consideration of the above problems, and has as its object to provide a structured data retrieval method which can easily and reliably retrieve structured data that contains an element having desired data as an element value independently of data structures upon searching a plurality of structured data with different data structures for desired structured data, and a structured data retrieval apparatus using the method.

### BRIEF SUMMARY OF THE INVENTION

(1) According to first aspect of the present invention, there is provided a data retrieval method comprising: storing a plurality of information data items in a first memory device, each of the information data items including one or more elements of a plurality of elements, each of the elements including a first element name and a first character string; storing a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string; inputting a search request including a keyword and a first label which is one of the labels; searching one of the first data items which includes the label being equal to the first label, to obtain a third element name which is the second element name included in the one of the first data items; searching one of the information data items which includes a first element of the elements which includes the third element name and a second element of the elements which includes the first character string including the keyword; outputting the first character string which is included in the first element.

(2) According to second aspect of the present invention, there is provided a data retrieval method comprising: storing a plurality of information data items in a first memory device, each of the information data items including one or more elements of a plurality of elements, each of the elements including a first element name and a first character string; storing a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string; storing a plurality of third data items in a third memory device, each of the third data items including one of the labels and a word representing one of the categories corresponding to the one of the label; inputting a search request expressed in natural-language and including a plurality of words; searching one of the third data items which includes the one of the words included in the search request, to obtain a first label which is one of the labels and is included in the one of the third data items; extracting a keyword corresponding to another of the words, from the search request; searching one of the first data items which includes the label being equal to the first label, to obtain a third element name which is the second element name included in the one of the first data items; searching one of the information data items which includes a first element of the elements which includes the third element name and a second element of the elements which includes the first character string including the keyword; outputting the first character string which is included in the first element.

### BRIEF DESCRIPTION OF THE SEVERAL VIEWS OF THE DRAWING

FIG. 1 is a block diagram showing an example of the arrangement of a commodity information retrieval apparatus according to the first embodiment of the present invention;

FIG. 2 shows a practical example of commodity information data;

FIG. 3 shows a practical example of commodity information data;

FIG. 4 shows a practical example of commodity information data;

FIG. 5 shows a practical example of commodity information data;

FIG. 6 shows a practical example of estimation knowledge data held in a first estimation knowledge storing unit;

FIG. 7 is a flowchart for explaining the processing operation of a first estimating unit;

FIG. 8 shows a practical example of estimation result data (data as one set of a label, tag, and shop name) stored in an estimation result storing unit;

FIG. 9 shows a practical example of another estimation result data stored in the estimation result storing unit;

FIG. 10 shows an example of a search request input window;

FIG. 11 shows a display example of a label list;

FIG. 12 shows the search request input window input with the search request;

FIG. 13 shows an example of first conversion knowledge data stored in a conversion knowledge storing unit;

FIG. 14 shows an example of second conversion knowledge data stored in the conversion knowledge storing unit;

FIG. 15 is a flowchart for explaining the processing operation for generating a first query or search statement in that of a search request converting unit;

FIG. 16 is a flowchart for explaining the processing operation for generating a second search statement in that of the search request converting unit;

FIG. 17 shows a practical example of the first search statement;

FIG. 18 shows a practical example of the second search statement;

FIG. 19 shows an example of a search result obtained by executing the first search statement (by making a pre-search);

FIG. 20 shows a display example of a search result as an execution result of the second search statement;

FIG. 21 is a block diagram showing an example of the arrangement of a commodity information retrieval apparatus according to the first modification of the first embodiment;

FIG. 22 shows an example of an input window of a search request using a natural sentence, and a search request input to the input window;

FIG. 23 shows a practical example of estimation knowledge data stored in a second estimation knowledge storing unit;

FIG. 24 is a flowchart for explaining the estimation processing operation for estimating a label and keyword in a second estimating unit;

FIG. 25 shows an example of second conversion knowledge data used when a label is “indefinite”;

FIG. 26 shows an example of a second conversion command generated by the search request converting unit;

FIG. 27 shows an example of an amending window used to amend a label and keyword estimated from the input search request;

FIG. 28 is a block diagram showing an example of the arrangement of a commodity information retrieval apparatus according to the second modification of the first embodiment; and

FIG. 29 shows a display example of an amending window used to amend a second search statement.

### DETAILED DESCRIPTION OF THE INVENTION

Preferred embodiments of the present invention will be described hereinafter with reference to the accompanying drawings.

### First Embodiment

The first embodiment adopts XML (Extensible Markup Language) as a description language of structured data. Also, the first embodiment will exemplify a commodity information retrieval apparatus that searches various commodity information data of a plurality of shops for desired information. The commodity information retrieval apparatus stores commodity information data (structured data) of a plurality of shops by collecting catalog data published on, e.g., the Internet by respective shops. The collected commodity information data (structured data) have different structures for respective shops, and their structures may be updated without prior notice.

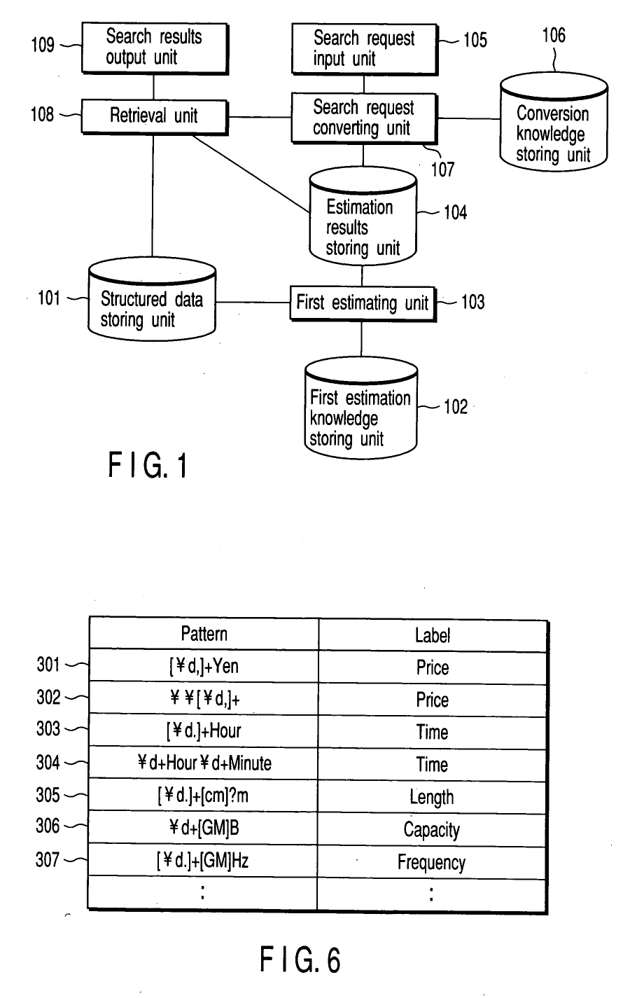

FIG. 1 shows an example of the arrangement of the commodity information retrieval apparatus according to the first embodiment.

A structured data storing unit 101 stores commodity information data which are collected by a data collection means (not shown) from the Internet and are described in XML. Each commodity information data is structured data which has a hierarchical data structure consisting or including of a plurality of elements. Each element has an element name (which is called tag or tag name) corresponding to its name, and has data (text data, image data, or audio data) as an element value.

A first estimation knowledge storing unit 102 stores estimation knowledge data used to estimate the types of element values in the commodity information data.

A first estimating unit 103 estimates the types of element values of elements of commodity information data stored in the structured data storing unit 101 using the estimation knowledge data stored in the first estimation knowledge storing unit 102, and stores estimation results in an estimation results storing unit 104. The estimation results storing unit 104 stores a table that indicates relationships between the values (element values) of elements of commodity information data and labels corresponding to the types estimated by the first estimating unit 103.

A search request input unit 105 accepts a search request input by the user, and sends it to a search request converting unit 107.

A conversion knowledge storing unit 106 stores conversion knowledge data used to convert the input search request into a query language that a retrieval unit 108 can interpret. For example, this embodiment adopts XQUERY as the query language.

The search request converting unit 107 converts the search request into a query language that the retrieval unit 108 can interpret with reference to the conversion knowledge data stored in the conversion knowledge storing unit 106.

The retrieval unit 108 retrieves structured data such as commodity information data stored in the structured data storing unit 101, estimation results stored in the estimation results storing unit 104, and the like on the basis of a query statement described in XQUERY as a conversion result of the search request converting unit 107.

The retrieval unit 108 may use a known XML database management system. Since the retrieval method itself is not the gist of the present invention, a description thereof will be omitted.

A search results output unit 109 is used to present the search result of the retrieval unit 108 to the user.

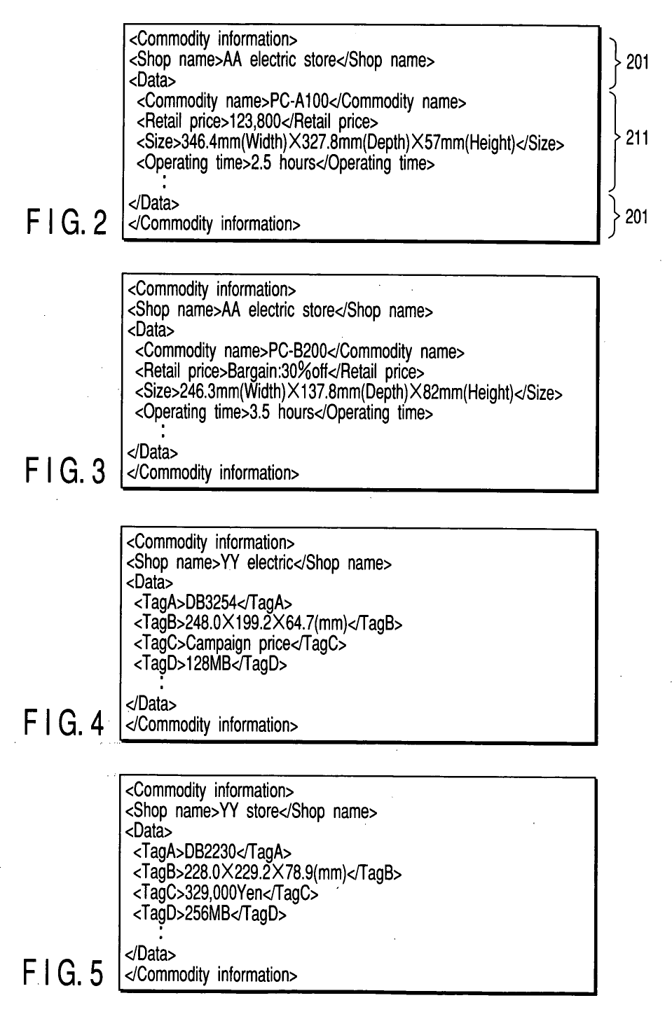

FIGS. 2 to 5 show examples of commodity information data (structured data) stored in the structured data storing unit 101.

Each commodity information data is expressed in XML, as shown in, e.g., FIG. 2, and contains raw data 211 collected by the collection means from each shop, and added data 201 (added by, e.g., the collection means) other than the raw data, which is used to arrange raw data for respective shops. The raw data 211 corresponds to a field bounded by <data> tags. The same applies to FIGS. 3 to 5.

The structured data storing unit 101 stores a plurality of structured data mentioned above.

FIG. 6 shows an example of estimation knowledge data which is stored in the first estimation knowledge storing unit 102 and is used to estimate the types of element values in commodity information data.

This embodiment exemplifies estimation knowledge data in a table format, but the present invention is not limited to such specific format. For example, the estimation knowledge data can be stored as, e.g., XML data expressed using XML in the same manner as in the structured data storing unit 101.

Each estimation knowledge data shown in FIG. 6 is expressed by a pair of a pattern expressed using, e.g., Perl language (see Larry Wall et al., “Perl Programming”, SOFTBANK CORP. pp. 31-32), and a label corresponding to the pattern. The pattern standardizes and expresses a type which can be classified based on the meaning, role, and the like of contents expressed as an element value. One label corresponds to one type, and one or a plurality of patterns correspond to one label.

For example, estimation knowledge data 301 consists of a label “price” and a pattern corresponding to that label (i.e., type). This pattern expresses a character string characters “yen” immediately after a string of one or more numerals and commas (,)” like “1000 yen”, “1,000 yen”, and the like. Also, estimation knowledge data 302 consists of a label “price” and another pattern corresponding to that label (i.e., type) as in the estimation knowledge data 301. This pattern expresses a character string which further has “\” at the head of the pattern expressed by the estimation knowledge data 301.

Estimation knowledge data 303 consists of a label “time” and a pattern corresponding to that label. This pattern expresses, e.g., a character string like “3.5 hours”. Estimation knowledge data 304 consists of a label “time” and another pattern corresponding to that label. This pattern expresses, e.g., a character string like “3 hours 5 minutes”.

Estimation knowledge data 305 consists of a label “length” and a pattern corresponding to that label. This pattern expresses, e.g., a character string like “10.5 cm”, “10.2 mm”, “10.1 m”, or the like.

Estimation knowledge data 306 consists of a label “capacity” and a pattern corresponding to that label. This pattern expresses, e.g., a character string like “10 GB”, “11 MB”, or the like.

Estimation knowledge data 307 consists of a label “frequency” and a pattern corresponding to that label. This pattern expresses, e.g., a character string like “1.8 GHz”, “1.9 MHz”, or the like.

As described above, each estimation knowledge data shown in FIG. 6 is formed by developing, when an element value is a character string, a certain pattern of the types and arrangement of characters which form the character string, and storing that pattern in correspondence with the type (label) of the element value.

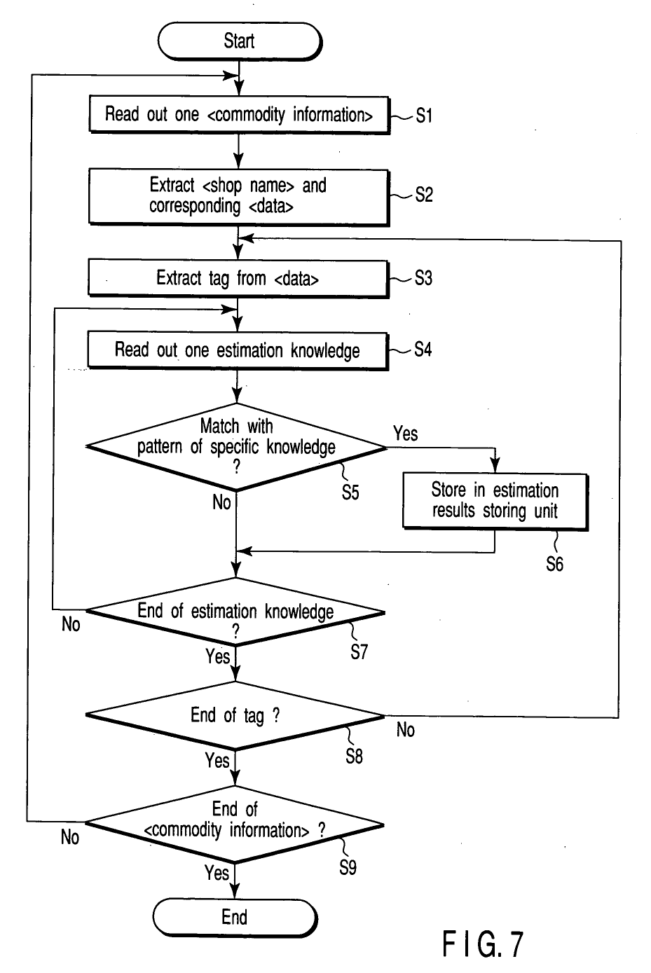

The processing operation of the first estimating unit 103 using the estimation knowledge data stored in the first estimation knowledge storing unit 102 will be described below with reference to FIG. 7.

The first estimating unit 103 reads out commodity information data as structured data one by one from the structured data storing unit 102 (step S1). As an example of commodity information data stored in the structured data storing unit 101, those shown in FIGS. 2 to 5 will be examined. In this case, step S1 corresponds to a process for extracting sub-trees after a <commodity information> tag (i.e., a field bounded by the <commodity information> tags) in turn from the structured data storing unit 101 as an XML database.

A shop name and data are extracted from the sub-trees after the <commodity information> tag acquired in step S1 (step S2). In this case, a process for extracting a value (element value) of a <shop name> tag and sub-trees after a <data> tag (i.e., a field bounded by the <data> tags) is executed.

In step S3, an element name (tag) of an element and its value (element value) are extracted in turn from the sub-trees after the <data> tag extracted in step S2. If one element contains another element (if an element has a hierarchical structure), contained tags are extracted in the order in which they appear, and child elements and subsequent elements which are contained as their values are removed.

In step S4, estimation knowledge data is read out one by one in turn from the first estimation knowledge storing unit 102. The first estimating unit 103 checks if the element value acquired in step S3 matches the pattern of the estimation knowledge data read out in step S4 (step S5) If the element value matches the pattern of the estimation knowledge data as a result of checking in step S5, the flow advances to step S6. In step S6, the tag name of that element value, a label corresponding to the estimation knowledge data, and the shop name corresponding to the commodity information having that tag name (this shop name is described as a value of a <shop name> tag in the commodity information) are stored as a set in the estimation results storing unit 104. After that, the flow advances to step S7.

In step S6, the tag name, label, and shop name are stored in the estimation results storing unit 104. However, the present invention is not limited to such specific case. The estimation results storing unit 104 need only store information, which can identify commodity information (and the shop name) to which the tag name stored in it belongs as an element, together with the tag name. For example, each element in structured data is considered as a node in a hierarchical structure (tree structure) of the structured data, and the location of a target element in the structured data can be expressed by arranging elements on a route from the head of the tree structure to the node of the target element. Such a route is called a path. The element (tag name) corresponding to the label may be expressed using the path.

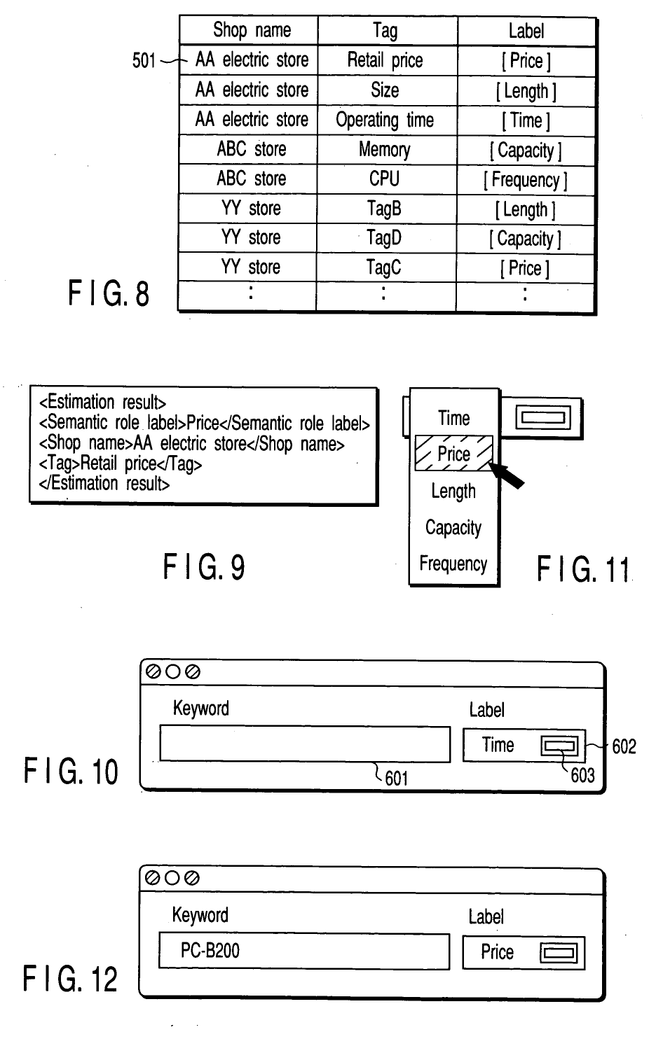

FIGS. 8 and 9 show data storage examples of estimation results stored in the estimation results storing unit 104. Note that the data structures of estimation results in FIGS. 8 and 9 will be described later.

If none of element values match the pattern of the estimation knowledge data in step S5, the flow advances to step S7. Until it is determined in step S7 that the checking process of the element values extracted in step S3 using all estimation knowledge data stored in the first estimation knowledge storing unit 102 is complete, steps S4 to S6 are repeated.

If it is determined in step S7 that the checking process of the element values extracted in step S3 using all estimation knowledge data is complete, the flow advances to step S8.

It is checked in step S8 if all tags have been extracted from the sub-trees after the <data> tag extracted in step S2. If tags to be extracted still remain, the flow returns to step S3.

If it is determined in step S8 that all tags have been processed, the flow advances to step S9 to check if all pieces of commodity information are read out from the structured data storing unit 101. If commodity information to be read out still remains, the flow returns to step S1 to repeat steps S1 to S8. If all pieces of commodity information have been processed, the process ends.

In this case, the flow that reads out and processes all structured data (commodity information) pre-stored in the structured data storing unit 101 has been explained. When new commodity information is added to the structured data storing unit 101, the added commodity information can be processed in turn in the same sequence as in FIG. 7.

The processing operation of the first estimating unit 103 shown in FIG. 7 will be described in detail below using the commodity information shown in FIG. 2 and the estimation knowledge data shown in FIG. 6.

In step S1, one commodity information is read out from the structured data storing unit 101. Assume that the commodity information shown in FIG. 2 is read out.

In step S2, “AA electric store” as “shop name” and a field 211 bounded by the <data> tags as “data” are extracted from the commodity information shown in FIG. 2.

In step S3, a tag and its value (element value) are extracted in turn from the field 211 bounded by the <data> tags. Assume that a <commodity name> tag and its value “PC-A100” are extracted first.

In step S4, estimation knowledge data is read out 25 in turn from the top one of the estimation knowledge data shown in FIG. 6. Assume that the estimation knowledge data 301 is read out. In this case, since the pattern of the estimation knowledge data 301 does not match “PC-A100” in step S5, the flow advances to step S7.

After that, steps S4 to S7 are repeated. However, “PC-A100” does not match any of the estimation knowledge data in FIG. 8, and the flow advances to step S8.

The flow returns from step S8 to step S3, and a <retail price> tag and its value “123,000 yen” are then extracted from the field 211 bounded by the <data> tags.

In step S4, the estimation knowledge data is read out in turn again. Assume that the estimation knowledge data 301 is extracted as in the above case.

Since the pattern of the estimation knowledge data 301 matches “123,000 yen”, the flow advances to step S6.

In step S6, “/commodity information [shop name=“AA electric store”]/data/retail price” as XQUERY expression (a type of path expression) of the <retail price> tag, and “price” as the label of the estimation knowledge data 301 are stored as a set in the estimation results storing unit 104. Then, the flow advances to step S7.

Likewise, steps S4 to S7 are repeated until all estimation knowledge data in FIG. 6 are read out in turn, and all the estimation knowledge data are read out in step S7. Also, steps S3 to S8 are repeated until all tags are extracted from the field 211 bounded by the <data> tags. Furthermore, steps S1 to S9 are repeated for all pieces of commodity information shown in, e.g., FIGS. 2 to 5, which are stored in the structured data storing unit 101.

The aforementioned label estimation result is stored in the estimation results storing unit 104, as shown in, e.g., FIG. 8. For example, first estimation result data 501 in FIG. 8 is applied to both pieces of commodity information shown in FIGS. 2 and 3 according to its shop name, but the label is estimated by the estimation processing operation in FIG. 7 in correspondence with only the commodity information shown in FIG. 2. This means that the type of an element value can be estimated to determine a label in correspondence with that type even for a tag whose element value does not match the pattern of estimation knowledge data in practice, by expressing the estimation result data, as shown in FIG. 8.

FIG. 8 shows the estimation result data in a frame format. As an implementation method, each estimation result can be stored as XML data expressed in XML in the estimation results data storing unit 104 as in structured data storing unit 101, as shown in, e.g., FIG. 9. In this case, the retrieval unit 108 can retrieve an estimation result from the estimation results storing unit 104 in the same manner as structured data stored in the structured data storing unit 101. In the following description of this embodiment, assume that estimation result data is expressed in XML, as shown in FIG. 9, and is recorded on the same database as the structured data storing unit 101.

In the description of FIG. 7, if the pattern of estimation knowledge data matches the element value in step S5, the flow immediately advances to step S6 to store an estimation result. However, the present invention is not limited to such a specific case. For example, if a single tag matches patterns corresponding to labels of different estimation knowledge data, data as pairs of tags and corresponding labels may be compiled for each shop name extracted in step S2, and estimation may be made statistically (by, e.g., a method of selecting a label that matches at the highest frequency).

FIGS. 10 to 12 are views for explaining a sequence for inputting a search request to the search request input unit 105. In order to input a search request, the search request input unit 105 displays a search request input window shown in, e.g., FIG. 10. This search request input window includes a keyword input field 601 and label input field 602.

FIG. 10 shows the initial state of the search request input window. When the user “wants to know “price” of “PC-B200””, he or she inputs “PC-B200” as a keyword to the keyword input field 601, and then inputs a label to the label input field 602. In order to input a label, the user selects a button 603 provided to the label input field 602. Then, a list of selectable labels is displayed, as shown in FIG. 11. The user selects a desired label (e.g., “price” in this case) from this list.

A search request (see FIG. 12) which contains the keyword and label input in this way can be internally held as, e.g., expression “label=“price”, keyword=“PC-B200””. Of course, the search request may be held in XML format.

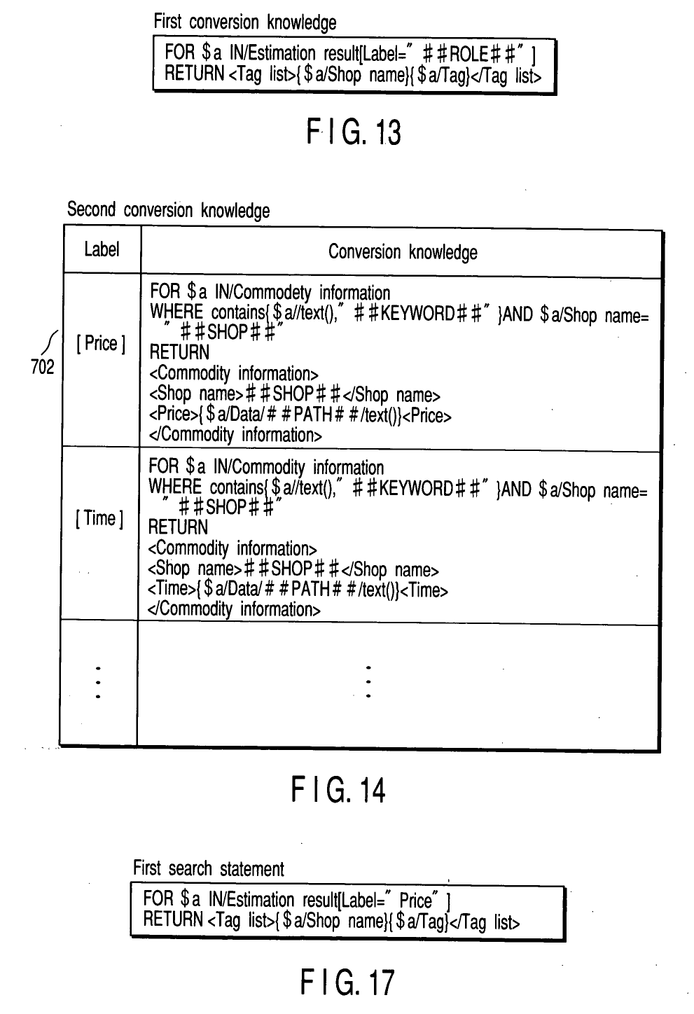

FIGS. 13 and 14 show examples of conversion knowledge data stored in the conversion knowledge storing unit 106.

FIG. 13 shows conversion knowledge (first conversion knowledge) data used to generate a first search statement for a pre-search. FIG. 14 shows conversion knowledge (second conversion knowledge) data used to generate a second search statement for searching commodity information stored in the structured data storing unit 101.

In this embodiment, two search processes, i.e., a pre-search (first search) using the first search statement and a second search using the second search statement, are made in response to the search request input by the user.

The first conversion knowledge data shown in FIG. 13 is conversion knowledge data used to generate the first search statement that searches the estimation results storing unit 104 for an element (tag name) corresponding to the label contained in the user's search request, and the shop name.

The second conversion knowledge data shown in FIG. 14 is conversion knowledge data used to convert the user's search request into a search statement (second search statement) using the pre-search results. Each conversion knowledge data is stored in the conversion knowledge storing unit 106 in association with one of a plurality of labels (stored in the first estimation knowledge storing unit 102).

In this embodiment, the first and second conversion knowledge data are expressed in a format that uses a part of a format called the FLWR syntax of XQUERY as a substitute character string.

In the first conversion knowledge data shown in FIG. 13, a string “##ROLE##” is a substitute character string to be substituted by the label which is input by the user as the search request is substituted. As a result, a first search statement described in the query language XQUERY is generated in this case. Note that the conversion knowledge storing unit 106 may store a plurality of different first conversion knowledge data.

The first conversion knowledge data shown in FIG. 13 is used to generate the first search statement for searching the estimation results storing unit 104 for an element corresponding to the label contained in the search request, and has a description for this purpose in the query language XQUERY. Note that the first search statement to be generated is used to retrieve an element corresponding to the label contained in the search request, and “shop name” in commodity information having that element as a search result. The first conversion knowledge data except for the substitute character string is described in the predetermined query language, and the first search statement is completed by substituting the substitute character string by the input label.

In the second conversion knowledge data shown in FIG. 14, strings “##ROLE##”, “##KEYWORD##”, “##SHOP##”, and “##PATH##” are substitute character strings. These substitute character strings are substituted according to the search request or pre-search request in a sequence to be described later. As a result, a second search statement described in the query language XQUERY is generated. Note that the second search statement to be generated contains an element corresponding to the label contained in the search request, and is used to retrieve commodity information that contains an element having the keyword contained in the search request as an element value, and to obtain “shop name” and the element value of the element corresponding to the label from the retrieved commodity information as a search result.

The second conversion knowledge data except for the aforementioned substitute character strings is described in the predetermined query language, and the second search statement is completed by substituting the substitute character strings by the label and keyword input by the user, and the shop name and tag name obtained as the pre-search result.

In this embodiment, these substitute character strings are used as reserved words. Of course, the expression method of substitute character strings is not limited to such specific example. For example, if a substitute character string is expressed using escape characters which never appear in data, collision between the reserved words and data can be avoided.

In FIG. 14, the conversion knowledge data is expressed in table format. For example, the conversion knowledge data may be described in XML, and may be stored in the same manner as in the structured data storing unit 101.

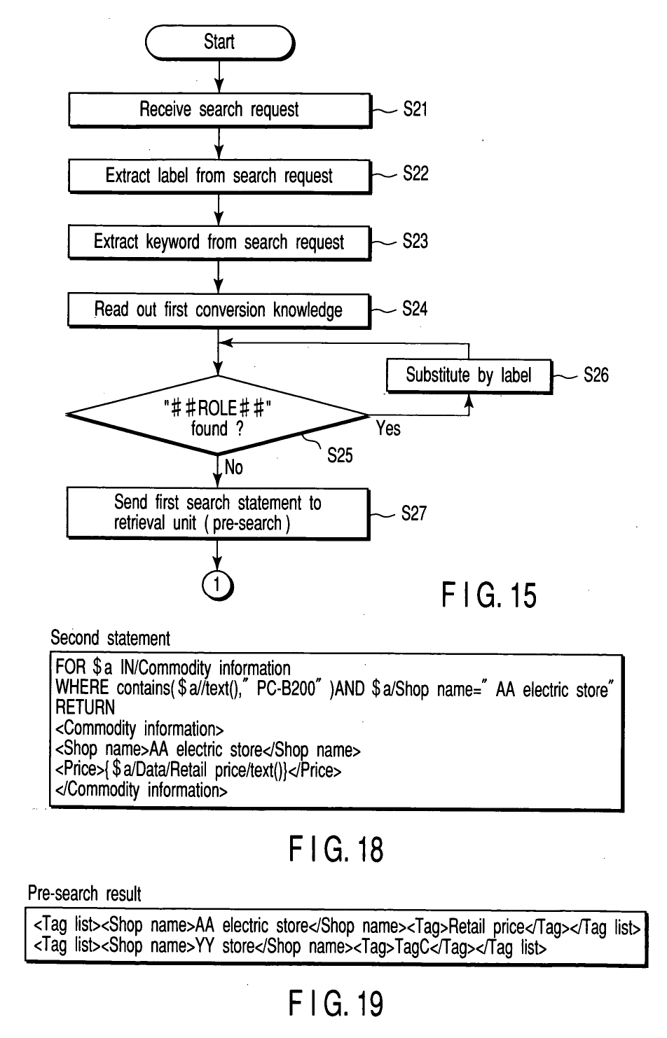

The processing operation of the search request converting unit 107 will be described below with reference to the flowchart shown in FIG. 15. In this case, the processing operation for generating the first search statement will be explained.

In step S21, the search request converting unit 107 receives a search request (containing a keyword and label) from the search request input unit 105. In steps S22 and S23, the label and keyword contained in the search request are acquired, respectively.

In step S24, the first conversion knowledge data is read out from the conversion knowledge storing unit 106. If the readout conversion knowledge data includes a substitute character string “##ROLE##” (step S25), it is substituted by the label acquired in step S22 (step S26). The processes in steps S25 and S26 are repeated until all substitute character strings “##ROLE##” in the conversion knowledge data are substituted (step S25), thus generating a first search statement.

In step S27, the first search statement is output to the retrieval unit 108. The retrieval unit 108 performs a pre-search based on the first search statement. That is, the retrieval unit 108 obtains a tag stored in association with the label designated as the search condition in the first search statement, and a shop name in commodity information that includes that tag as a search result. Since the XML data search method in the retrieval unit 108 is the same as that in a known, public use XML retrieval system or the like, and is not the gist of the present invention, a detailed description thereof will be omitted.

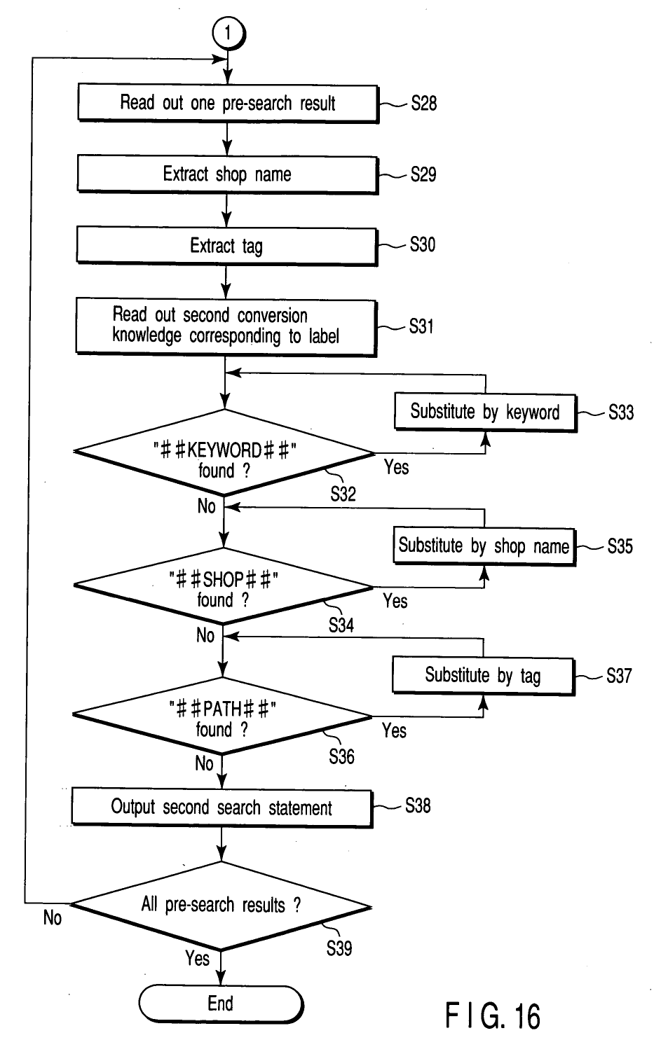

FIG. 16 is a flowchart for explaining the processing operation of the search request converting unit 107 which converts the user's search request into a second search statement using the pre-search result obtained in step S27 in FIG. 15.

One pre-search result data consists of one tag name and shop name (in commodity information including that tag name). Assume that at least one pre-search result is obtained.

In step S28, one pre-search result data is read out, and a shop name (step S29) and tag (step S30) are extracted from the pre-search result.

The second conversion knowledge data corresponding to the label acquired in step S22 in FIG. 15 is read out from the conversion knowledge storing unit 106 (step S31). If the readout second conversion knowledge data includes a substitute character string “##KEYWORD##” (step S32), it is substituted by the keyword in the search request acquired in step S23 in FIG. 15 (step S33). This process is repeated until all substitute character strings “##KEYWORD##” in the second conversion knowledge data are substituted.

If the readout second conversion knowledge data contains “##SHOP##” (step S34), it is substituted by the shop name in the pre-search result acquired in step S29 (step S35). This process is repeated until all substitute character strings “##SHOP##” in the second conversion knowledge data are substituted.

Likewise, if the readout conversion knowledge data contains a substitute character string “##PATH##” (step S36), it is substituted by the tag name in the pre-search result acquired in step S30 (step S37). This process is repeated until all substitute character strings “##PATH##” in the second conversion knowledge data are substituted.

In this manner, a second search statement is generated. The generated second search statement is output to the retrieval unit 108 (step S38).

If another pre-search result is available, the flow returns to step S28 to read out the next pre-search result and to repeat the aforementioned process. After all pre-search results are read out, this flow ends (step S39).

The processing operation shown in FIGS. 15 and 16 will be described in detail below taking as an example a case wherein the search request converting unit 107 receives a search request, which contains the label and keyword shown in FIG. 12, in step S21.

In this case, “price” is extracted as the label in step S22, and “PC-B200” is extracted as the keyword in step S23. In step S24, the first conversion knowledge data shown in FIG. 13 is read out, and a substitute character string “##ROLE##” is retrieved from this first conversion knowledge data (step S25) and is substituted by label “price” acquired in step S22 (step S26). As shown in FIG. 13, since the substitute character string “##ROLE##” appears only once in the first conversion knowledge data, step S26 is processed only once in this case.

As a result of the above process, the first search statement shown in FIG. 17 is generated. This first search statement is passed to the retrieval unit 108 to start a pre-search (step S27).

The first search statement is sent to the retrieval unit 108 to execute a pre-search process. Since this operation is the same as an existing XML retrieval system, a detailed description thereof will be omitted.

Assume that two pre-search result data are obtained by this pre-search process, as shown in, e.g., FIG. 19.

The processing operation in FIG. 16 will be described in detail below. In step S28, the first pre-search result “<tag list><shop name>AA electric store</store name><tag>retail price</tag></tag list>” of the pre-search results shown in FIG. 19 is read out. From this pre-search result, “AA electric store” as the shop name (step S29) and “retail price” as the tag (step S30) are extracted.

Second conversion knowledge data 702 in FIG. 14 is read out as that corresponding to the label “price” extracted from the search request in step S22 (step S31). A substitute character string “##KEYWORD##” in the second conversion knowledge data 702 is substituted by the keyword “PC-B200” extracted from the search request in step S23 (step S32). Since “##KEYWORD##” appears only once in the second conversion knowledge data 702, step S33 is processed only once (step S32).

Likewise, a substitute character string “##SHOP##” in the second conversion knowledge data 702 is substituted by the shop name “AA electric store” extracted from the pre-search result data in step S29 (step S35). Since “##SHOP##” appears twice in the second conversion knowledge data 702, step S35 is processed twice (step S34). A substitute character string “##PATH##” in the second conversion knowledge data 702 is substituted by the tag “retail price” extracted from the pre-search result data in step S30 (step S37). Since “##PATH##” appears only once in the second conversion knowledge data 702, step S37 is processed only once (step S36).

A second search statement in the XQUERY format, which is generated in this way, is output in step S38. FIG. 18 shows the generated second search statement.

Since two pre-search result data are available, as shown in FIG. 19, the process is repeated from step S28 via step S39.

In the second loop, pre-search result data “<tag list><shop name>YY store</store name><tag>TagC</tag></tag list>” is read out (step S28), and steps S29 to S38 are processed in the same manner as in the first loop.

Since there are two pre-search result data, the flow ends when it reaches step S39 for the second time.

In this example, the search request converting unit 107 outputs two second search statements. Based on the first second search statement, the retrieval unit 108 searches commodity information with the shop name “AA electric store” stored in the structured data storing unit 101 for commodity information which contains (1) an element having the keyword contained in the search request as an element value, and (2) an element corresponding to the label contained in the search request. Also, based on the second search statement, the retrieval unit 108 searches commodity information of “YY store” for commodity information which satisfies (1) and (2) above.

According to the first second search statement, the value of the <shop name> tag and the value of the <retail price> tag corresponding to the label “price” in the retrieved commodity information are obtained as a search result. According to the second search statement, the value of the <shop name> tag and the value of the <TagC> tag corresponding to the label “price” in the retrieved commodity information are obtained as a search result.

Since the retrieval unit 108 can be implemented by an existing XML database management system which can process a query language such as XQUERY and the like, a detailed description of its operation will be omitted.

Upon examining the commodity information shown in FIGS. 2 to 5 as practical XML data which are to undergo a search process, the second search statement shown in FIG. 18 retrieves the commodity information shown in FIG. 3 as data which contains a character string “PC-B200”, and the contents of the retrieved commodity information are reconfigured according to the description of a “RETURN” clause described in the second search statement shown in FIG. 18, thus outputting search result data.

As for the second search statement output in the second loop in FIG. 16, no commodity information that meets the search conditions (1) and (2) in this second search statement is found from those shown in FIGS. 2 to 5. Hence, no search result is obtained.

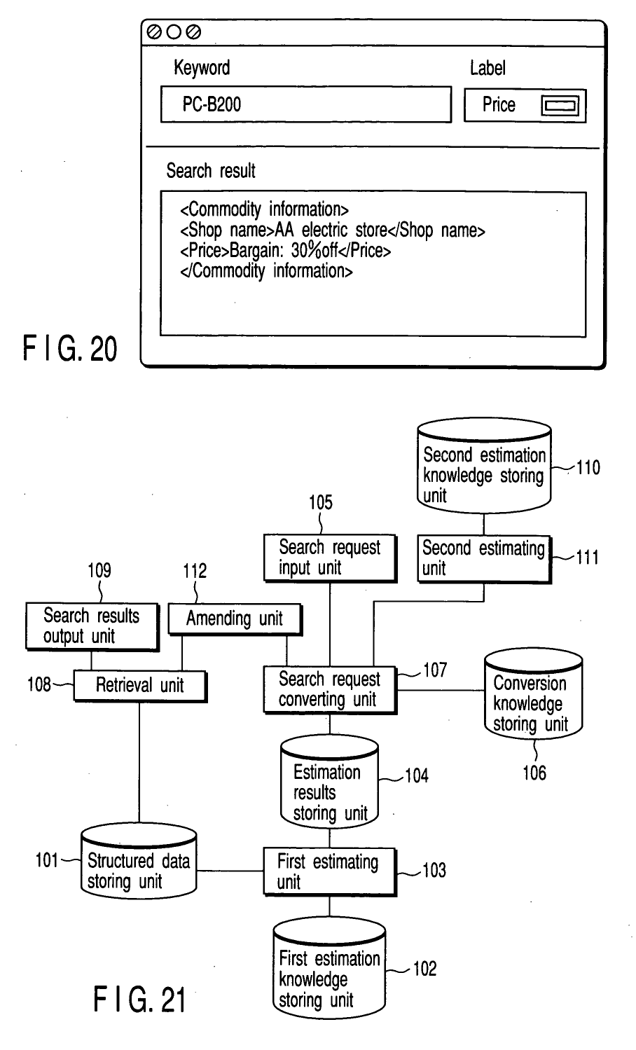

The search results output unit 109 displays the search result, as shown in, e.g., FIG. 20. FIG. 20 shows an example of only one search result. If a plurality of pieces of commodity information are retrieved, they are displayed in a list. Also, the expression obtained from the retrieval unit 108 is directly output as the search result. However, the present invention is not limited to such specific case. For example, the search results output unit 109 may convert the search result into a natural sentence like “PC-B200 is bargain: 30% off at AA electric store” and output the converted sentence.

As described above, according to the first embodiment, the types of element values of respective elements in structured data, which are stored in the structured data storing unit 101 and each of which has a hierarchical data structure consisting of a plurality of elements, are estimated, and the element names of the structured data and labels corresponding to the types estimated based on the element values of the elements are stored in the estimation results storing unit 104 in association with each other. When a search request that contains a keyword and label is input, an element name corresponding to the label contained in the search request is retrieved from information stored in the estimation results storing unit 104. Next, structured data which contains the retrieved element, and an element which has the keyword contained in the search request as an element value, is retrieved from those stored in the structured data storing unit 101. Of the retrieved structured data, at least an element value of the element corresponding to the label contained in the search request is output as a search result.

With this arrangement, even when the data structure of commodity information is unknown, or the type of an element value such as a semantic role of each individual data contained as an element value in a conventional means is unknown, the user need only input a keyword (e.g., product name “PC-B200” and a label (e.g., “price”) corresponding to the type of an element value to retrieve desired information, which contains an element having the keyword as an element value, and an element having an element name corresponding to the label. From the information which contains the element having the keyword as the element value, the element value (e.g., “bargain: 30% OFF”) of the element with the element name corresponding to the label that the user wants to know can be obtained as a search result.

More specifically, upon searching a plurality of structured data with different data structures for desired structured data, structured data which contains an element having desired information data as an element value can be easily and reliably retrieved independently of its data structure (by designating a label corresponding to the type of data to be retrieved without knowing an accurate element name).

According to the first embodiment, the user need only input a search request that contains a desired label and keyword to retrieve structured data that contains an element corresponding to the label and the keyword. That is, according to the first embodiment, structured data that contains an element having desired data as an element value can be easily and reliably retrieved independently of its data structure (by designating a label corresponding to the type of data to be retrieved without knowing an accurate element name) upon searching a plurality of structured data with different data structures for desired structured data.

Preferably, a pattern (a character string pattern) which is determined for each type (or category) of an element value, and represents the types and arrangement of characters of a character string that belongs to that type of the element value is stored in advance in association with a label corresponding to the type. Upon estimating the type of an element value of an element of each structured data, the types and arrangement of characters of a character string as the element value of that element are compared with the pre-stored patterns, and a label corresponding to a pattern which matches the element value is obtained.

### First Modification of First Embodiment

The first modification of the first embodiment will be described below. A commodity information retrieval apparatus according to the first modification can receive a search request input in a natural language from the user. The apparatus estimates a label from the input search request in a natural language, and performs a search based on the estimation result.

FIG. 21 shows an example of the arrangement of the commodity information retrieval apparatus according to the first modification. Note that the same reference numerals in FIG. 21 denote the same parts as those in FIG. 1, and only differences will be explained. That is, in FIG. 21, a second estimating unit 111 and second estimation knowledge storing unit 110, which are used to estimate words corresponding to a label and keyword from a search request of a natural sentence input from the search request input unit 105 by the user, are added. Furthermore, an amending unit 112 is added. The amending unit 112 has a function of presenting words corresponding to the label and keyword, which are estimated by the second estimating unit 111, and first and second search statements generated based on these words to the user, and allowing the user to amend them as needed.

The search request input unit 105 receives a search request which is input by the user and is described in a natural language, and sends it to the search request converting unit 107.

In the first modification, XQUERY is used as the query language as in the first embodiment.

The second estimation knowledge storing unit 110 stores estimation knowledge data used to estimate a label from the search request input from the search request input unit 105.

The search request converting unit 107 sends the search request passed from the search request input unit 105 to the second estimating unit 111 first. The second estimating unit 111 estimates words corresponding to a label and keyword, explained in the first embodiment, from the search request of the natural sentence on the basis of the estimation knowledge data stored in the second estimation knowledge storing unit 110. After that, the search request converting unit 107 generates first and second search statements on the basis of the estimated words corresponding to the label and keyword, as has been explained in the first embodiment. The generated first and second search statements are sent to the amending unit 112.

The amending unit 112 presents the words corresponding to the label and keyword, which are estimated by the second estimating unit 111, and the first and second search statements generated by the search request converting unit 107 to the user, and accepts an amendment from the user. The amending unit 112 passes the amended label and keyword to the search request converting unit 107 again, and sends the amended first and second search statements to the retrieval unit 108. Of course, if the label and keyword, and the first and second search statements need not be amended, they are directly sent to the search request converting unit 107 and retrieval unit 108.

The processing operations of the respective units will be described in detail below.

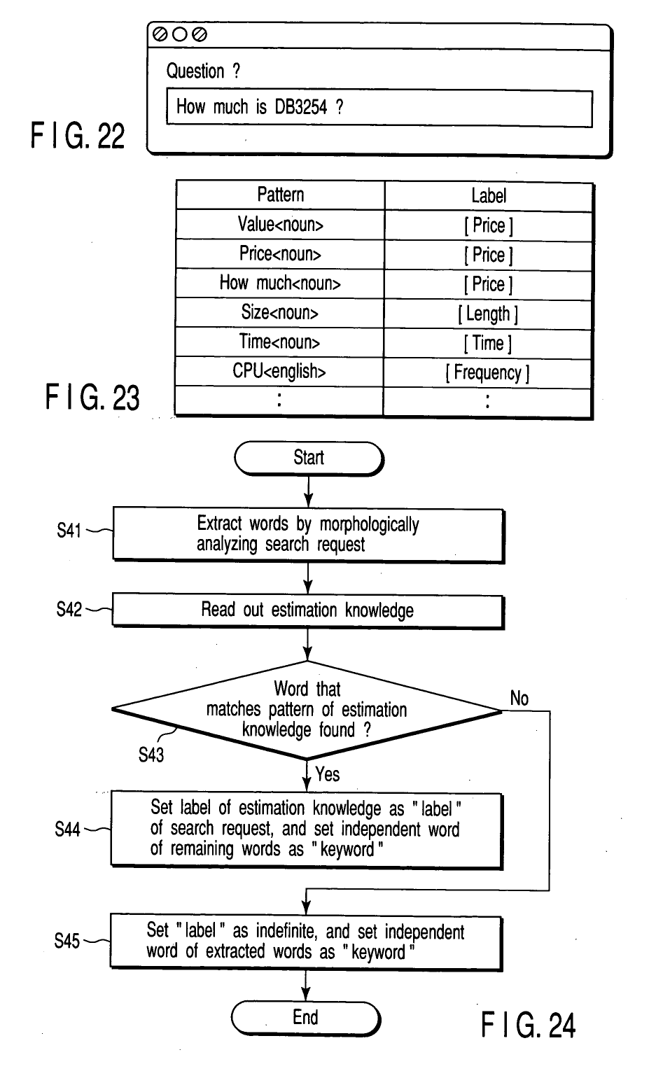

FIG. 22 shows a search request input window displayed by the search request input unit 105 in the first modification. In FIG. 22, a natural sentence “how much is DB3254?” is input as a search request.

The search request converting unit 107 receives that search request from the search request input unit 105, and sends it to the second estimating unit 111. The second estimating unit 111 extracts words corresponding to the label and keyword from the search request as an estimation result.

The second estimation knowledge storing unit 110 stores estimation knowledge data, as shown in, e.g., FIG. 23. The estimation knowledge data stored in this unit associates a label with a word which is estimated to designate that label (i.e., a word that represents the type of an element value of an element) that may be contained in a natural sentence of a search request. In this case, a word which is estimated to designate a word that represents the type of an element value of an element is called a pattern. According to the estimation knowledge data shown in FIG. 23, if the natural sentence of the search request contains the word “value”, “price”, “how much”, or the like, it is estimated based on such word that the search request designates a label “price”.

The estimation processing operation of words corresponding to the label and keyword in the second estimating unit 111 will be described below with reference to the flowchart shown in FIG. 24.

Upon reception of the search request input from the search request input unit 105, the second estimating unit 111 morphologically analyzes the search request to extract words from the search request (step S41). The second estimating unit 111 reads out estimation knowledge data (FIG. 23) stored in the second estimation knowledge storing unit 110 one by one, and checks if one of the extracted words matches the pattern of each estimation knowledge data. (step S42). If a word that matches the pattern of the estimation knowledge data is found (step S43), the second estimating unit 111 estimates a label in that estimation knowledge data as that contained in the search request. The second estimating unit 111 extracts, as a keyword, an independent word from the words extracted in step S41 except for the word corresponding to the label if it is available (step S44).

On the other hand, if none of words match the pattern of the estimation knowledge data in step S43, the flow jumps to step S45. In step S45, the second estimating unit 111 estimates a label as “indefinite” and extracts an independent word of those extracted in step S41 as a keyword if it is available.

For example, when the search request of the natural sentence shown in FIG. 22 is input, since a word “how much” in the natural sentence matches the pattern of the label “price”, “price” is extracted as the label. Also, since “DB3254” is an independent word of those other than “how much”, this word is extracted as a keyword.

The estimation result of the second estimating unit 111 can be held as expression ““label=“price”, keyword=“DB3254”” as in the search request input to the search request input unit 105 in the first embodiment.

If the estimation result is held in this way, the conversion process of the search request converting unit 107 of the first modification can be executed according to FIGS. 15 and 16, as in the first embodiment.

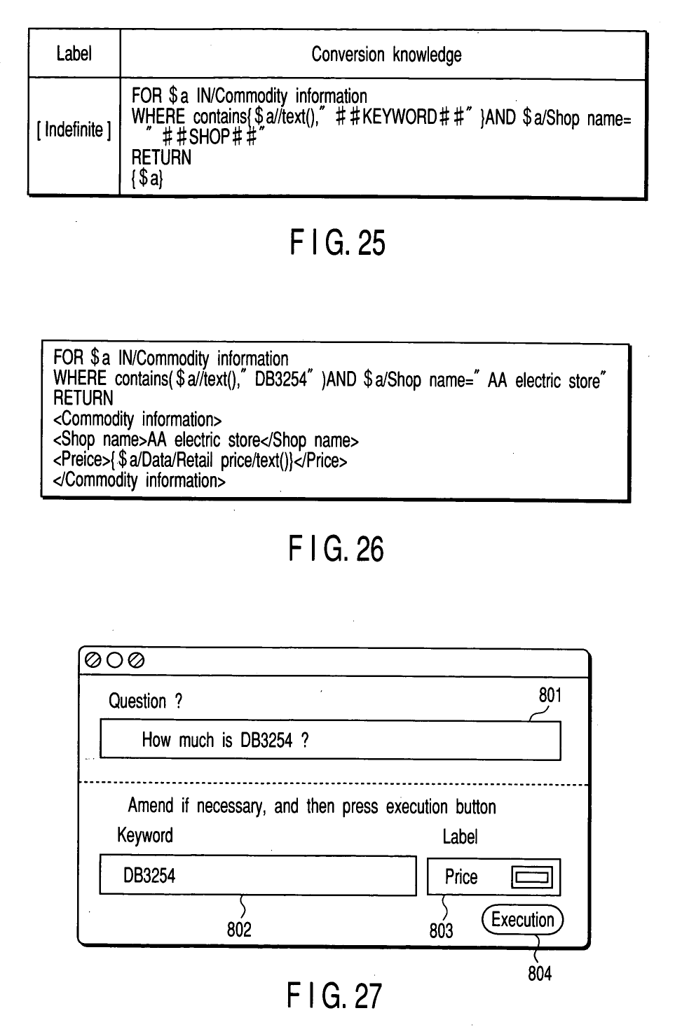

In the first modification, the second estimating unit 111 sometimes fails to estimate a label from the search request as in step S45 in FIG. 24 (a label is estimated as “indefinite”). FIG. 25 shows second conversion knowledge data when the label is “indefinite”.

In the second conversion knowledge data when the label is “indefinite”, as shown in FIG. 25, a second search statement used to search for commodity information that contains an element which has, as an element value, the word extracted as a keyword in step S45 in FIG. 24, is generated. The conversion knowledge storing unit 106 also stores the second conversion knowledge data when the label is “indefinite”, as shown in FIG. 25.

FIG. 26 shows one of second search statements generated by the search request converting unit 107 in the first modification. As in the first embodiment, the search request converting unit 107 often generates and outputs a plurality of second search statements.

The amending unit 112 displays an amending window shown in FIG. 27. This amending window includes an area 801 for displaying (and amending) the search request of the natural sentence input by the user, an area 802 for displaying (and amending) a word corresponding to the keyword extracted from the search request by the second estimating unit 111, and an area 803 for displaying (and amending) a label estimated from the search request.

The user can amend the keyword and label displayed in the areas 802 and 803 of this amending window if necessary.

The user may directly amend the estimation result of the second estimating unit 111 on the amending window shown in FIG. 27, or may re-input the search request of the natural sentence itself to amend the result.

When the user re-inputs the search request in the area 801, the second estimating unit 111 executes the estimation process shown in FIG. 24 again. Then, the estimation result of this process is displayed in the areas 802 and 803 in FIG. 27.

The user amends the search request if necessary, and presses a button 804 used to instruct execution of a search process if desired search conditions are set.

Assume that the user does not amend the search request in this case. Upon completion of amending of the search request, the amending unit 112 passes the keyword and label to the search request converting unit 107. The search request converting unit 107 generates first and second search statements using the keyword and label passed from the amending unit 112, as in the first embodiment. The subsequent processing operation is the same as that in the first embodiment.

As described above, according to the first modification, the types of element values of respective elements in structured data, which are stored in the structured data storing unit 101 and each of which has a hierarchical data structure consisting of a plurality of elements, are estimated, and the elements of the structured data and labels corresponding to the types estimated based on the element values of the elements are stored in the estimation results storing unit 104 in association with each other. When a search request of a natural sentence is input, the label is estimated from words contained in the natural sentence as the search request, and a word corresponding to the keyword is estimated. An element corresponding to the estimated label is retrieved from information stored in the estimation results storing unit 104. Next, structured data which contains the retrieved element, and an element which has the estimated keyword as an element value, is retrieved from those stored in the structured data storing unit 101. Of the retrieved structured data, at least the element value of the element corresponding to the label contained in the search request is output as a search result.

With this arrangement, even when the data structure of commodity information is unknown, or the type of an element value such as the semantic role of each individual data contained as an element value in a conventional means is unknown, when the user describes a question in a natural language (e.g., when he or she inputs “how much is DB3254?”), the label and keyword are estimated from that question. Then, desired information which contains an element having the keyword as an element value, and an element having an element name corresponding to the label is retrieved. From the information which contains the element having the keyword as the element value, the element value (e.g., “campaign price”) of the element with the element name corresponding to the label that the user wants to know can be obtained as an answer.

According to the first modification, when the user inputs a search request that expresses structured data to be retrieved using natural sentence, a label and keyword used in an actual search are estimated from the natural sentence. Then, structured data which contains an element corresponding to this label, and the keyboard, is retrieved. That is, according to the first modification, structured data that contains an element having desired data as an element value can be easily and reliably retrieved independently of its data structure (by designating a label corresponding to the type of data to be retrieved without knowing an accurate element name) upon searching a plurality of structured data with different data structures for desired structured data.

A pattern (a character string pattern) which is determined for each type (or category) of an element value, and represents the types and arrangement of characters of a character string that belongs to that type of the element value is stored in advance in association with a label corresponding to the type. Upon estimating the type of an element value of an element of each structured data, the types and arrangement of characters of a character string as the element value of that element are compared with the pre-stored patterns, and a label corresponding to a pattern which matches the element value is obtained.

In order to estimate the label from words contained in a natural sentence, pairs of labels and words which are estimated to designate the labels (words corresponding to the labels) are pre-stored. Upon estimating a label from the natural sentence, the natural sentence is searched for a word corresponding to the label.

### Second Modification of First Embodiment

Another modification of the first modification of the first embodiment will be explained below. In a commodity information retrieval apparatus according to the second modification, the amending unit 112 presents first and second search statements generated by the search request converting unit 107 to the user, and accepts amendments.

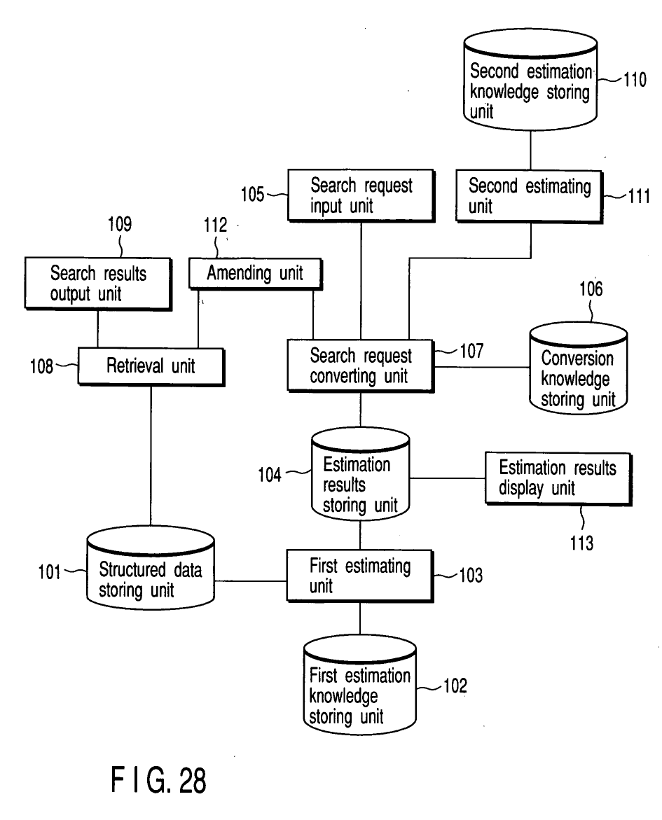

FIG. 28 shows an example of the arrangement of the commodity information retrieval apparatus according to the second modification. Note that the same reference numerals in FIG. 28 denote the same parts as those in FIGS. 1 and 21, and only differences will be explained. That is, in the arrangement shown in FIG. 28, an estimation results display unit 113, which displays the estimation result of the first estimating unit 103 for the user is added to the arrangement shown in FIG. 21.

Assume that the structured data storing unit 101 stores commodity information shown in, e.g., FIGS. 2 to 5, the second estimation knowledge storing unit 110 stores estimation knowledge data shown in FIG. 23, and the conversion knowledge storing unit 106 stores conversion knowledge data shown in FIGS. 13 and 14. A case will be examined below wherein the user inputs a search request “how much is DB3254?” at that time.

In this case, since a label “price” and a keyword “DB3254” are estimated from the search request, as described above, first and second search statements are generated from them, as described above.

For example, when a second search statement is generated, the amending unit 112 displays the second search statement to allow the user to amend that second search statement, and the estimation results display unit 113 displays the estimation results stored in the estimation results storing unit 104.

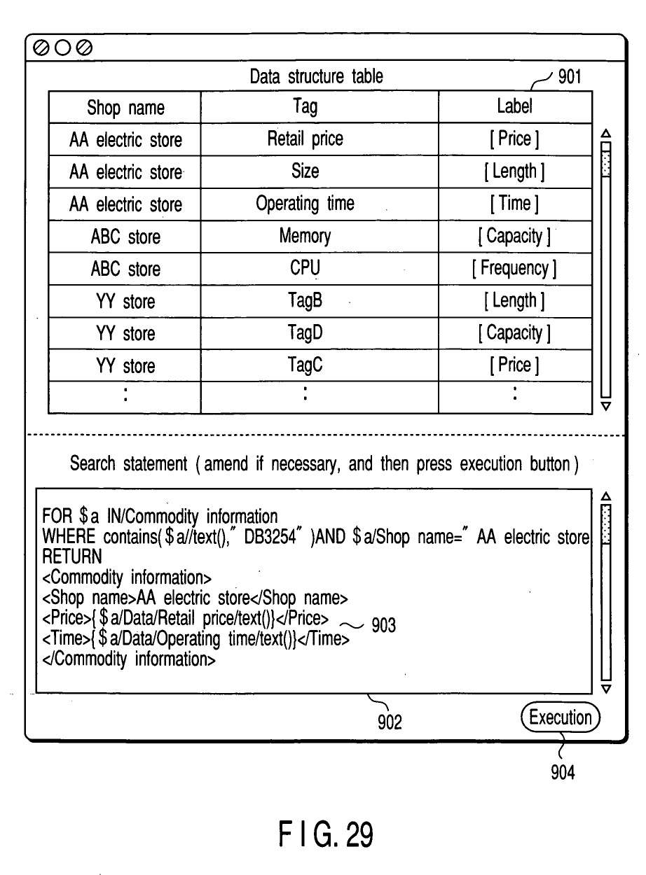

FIG. 29 shows a display window of an amending window of the second search statement. This amending window displays the second search statement and estimation results. As shown in FIG. 29, the second search statement and estimation results are displayed in a single window, i.e., the second search statement is displayed in an area 902, and the estimation results are displayed in an area 901.

The user amends the second search statement which is generated by the search request converting unit 107 and displayed in the area 902, with reference to the estimation results presented in the area 901, in the window shown in FIG. 29. For example, the user adds one line “<time>{$a/data/operating time/text( )}</time>” to the second search statement in the window shown in FIG. 29.

With this amendment, the user instructs to search for information associated with a time (perhaps, information about the duration of a battery) in addition to the search request “how much is DB3254?” input in advance.

After the second search statement has been amended, the user presses an execution button 904. Then, the amending unit 112 sends the amended second search statement to the retrieval unit 108. Since the subsequent processing operations of the retrieval unit 108 and search results output unit 109 are the same as those in the first embodiment, a description thereof will be omitted.

In case of the second modification, the user can issue a more elaborate search instruction with reference to the data structure of commodity information.

Also, the user must have knowledge about a query language (e.g., XQUERY) to some extent. However, since the user can input an initial search request in a natural language, he or she can make a search more easily than in the case wherein a search statement is formed using a query language from the beginning.

Note that the method of the present invention described in the embodiments of the present invention can be distributed by storing the method as a program that can be executed by a computer on a recording medium such as a magnetic disk (flexible disk, hard disk, or the like), optical disk (CD-ROM, DVD, or the like), semiconductor memory, or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data retrieval method comprising:
storing a plurality of information data items in a first memory device, each of the information data items including one or more elements, each of the elements including a first element name and a first character string;
storing a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
inputting a search request including a keyword and a first label which is one of the labels;
searching one of the first data items which includes the first label, to obtain a third element name which is the second element name included in the one of the first data items;
searching one of the information data items which includes a first element of the elements which includes the third element name and a second element of the elements which includes the first character string including the keyword;
outputting the first character string which is included in the first element.

2. A data retrieval method comprising: storing a plurality of information data items in a first memory device, each of the information data items including one or more elements, each of the elements including a first element name and a first character string;
storing a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
storing a plurality of third data items in a third memory device, each of the third data items including one of the labels and a word representing one of the categories corresponding to the one of the label;
inputting a search request expressed in natural-language and including a plurality of words;
searching one of the third data items which includes the one of the words included in the search request, to obtain a first label which is one of the labels and is included in the one of the third data items;
extracting a keyword corresponding to another of the words, from the search request;
searching one of the first data items which includes the first label, to obtain a third element name which is the second element name included in the one of the first data items;
searching one of the information data items which includes a first element of the elements which includes the third element name and a second element of the elements which includes the first character string including the keyword;
outputting the first character string which is included in the first element.

3. A method according to claim 1, which includes storing a plurality of character string patterns and the labels, each of the character string pattern corresponding to one of the categories,
comparing the first character string with the character string patterns, to obtain the label which corresponds to one of the categories to which the first character string belongs.

4. A method according to claim 2, which includes storing a plurality of character string patterns and the labels, each of the character string pattern corresponding to one of the categories,
comparing the first character string with the character string patterns, to obtain the label which corresponds to one of the categories to which the first character string belongs.

5. A data retrieval apparatus comprising:
a first storing unit configured to store a plurality of information data items, each of the information data items including one or more elements, each of the elements including a first element name and a first character string;
a second storing unit configured to store a plurality of first data items, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
an input unit configured to input a search request including a keyword and a first label which is one of the labels;
a first search unit configured to search one of the first data items which includes the first label, to obtain a third element name which is the second element name included in the one of the first data items;
a second search unit configured to search one of the information data items which includes a first element of the elements which includes the third element name and a second element of the elements which includes the first character string including the keyword;
a output unit configured to output the first character string which is included in the first element.

6. A data retrieval apparatus comprising:
a first storing unit configured to store a plurality of information data items, each of the information data items including one or more elements, each of the elements including a first element name and a first character string;
a second storing unit configured to store a plurality of first data items, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
a third storing unit configured to store a plurality of third data items, each of the third data items including one of the labels and a word representing one of the categories corresponding to the one of the label;
an input unit configured to input a search request expressed in natural-language and including a plurality of words;
a first search unit configured to search one of the third data items which includes the one of the words included in the search request, to obtain a first label which is one of the labels and is included in the one of the third data items;
an extracting unit configured to extract a keyword corresponding to another of the words, from the search request;
a second search unit configured to search one of the first data items which includes the first label, to obtain a third element name which is the second element name included in the one of the first data items;
a third search unit configured to search one of the information data items which includes a first element of the elements which includes the third element name and a second element of the elements which includes the first character string including the keyword;
an output unit configured to output the first character string which is included in the first element.

7. An apparatus according to claim 5, further comprising:
a fourth storing unit configured to store a plurality of character string patterns and the labels, each of the character string pattern corresponding to one of the categories,
a comparing unit configure to compare the first character string with the character string patterns, to obtain the label which corresponds to one of the categories to which the first character string belongs.

8. An apparatus according to claim 6, further comprising:
a fourth storing unit configured to store a plurality of character string patterns and the labels, each of the character string pattern corresponding to one of the categories;
a comparing unit configured to compare the first character string with the character string patterns, to obtain the label which corresponds to one of the categories to which the first character string belongs.

9. A data retrieval program stored on a computer readable medium, the computer program comprising:
first program instruction means for instructing a computer processor to store a plurality of information data items in a first memory device, each of the information data items including one or more elements, each of the elements including a first element name and a first character string;
second program instruction means for instructing a computer processor to store a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
third program instruction means for instructing a computer processor to input a search request including a keyword and a first label which is one of the labels;
fourth program instruction means for instructing a computer processor to search one of the first data items which includes the first label, to obtain a third element name which is the second element name included in the one of the first data items;
fifth program instruction means for instructing a computer processor to search one of the information data items which includes a first element of the elements which includes the third element name and a second element of the elements which includes the first character string including the keyword;
sixth program instruction means for instructing a computer processor to output the first character string which is included in the first element.

10. A data retrieval program stored on a computer readable medium, the computer program comprising:
first program instruction means for instructing a computer processor to store a plurality of information data items in a first memory device, each of the information data items including one or more elements, each of the elements including a first element name and a first character string;
second program instruction means for instructing a computer processor to store a plurality of first data items in a second memory device, each of the first data items including a second element name which is included in one of the elements and a label corresponding to one of categories to which a second character string which is included in the one of the elements belongs, the label being one of labels which correspond to the categories respectively, the second element name being identical to the first element name, the second character string being identical to the first character string;
third program instruction means for instructing a computer processor to storing a plurality of third data items in a third memory device, each of the third data items including one of the labels and a word representing one of the categories corresponding to the one of the label;
fourth program instruction means for instructing a computer processor to input a search request expressed in natural-language and including a plurality of words;
fifth program instruction means for instructing a computer processor to search one of the third data items which includes the one of the words included in the search request, to obtain a first label which is one of the labels and is included in the one of the third data items;
sixth program instruction means for instructing a computer processor to extracting a keyword corresponding to another of the words, from the search request;
seventh program instruction means for instructing a computer processor to search one of the first data items which includes the first label, to obtain a third element name which is the second element name included in the one of the first data items;
eighth program instruction means for instructing a computer processor to search one of the information data items which includes a first element of the elements which includes the third element name and a second element of the elements which includes the first character string including the keyword;
ninth program instruction means for instructing a computer processor to outputting the first character string which is included in the first element.
